(19) United States
(12) Patent Application Publication
(10) Pub. No.: US 2012/0280864 A1
(43) Pub. Date: Nov. 8, 2012

(54) POSITION SENSOR

(75) Inventor: Joshua Lanter, (US)

(73) Assignee: Polycontact AG

(21) Appl. No.: 13/462,982

(22) Filed: May 3, 2012

(30) Foreign Application Priority Data
May 4, 2011 (DE) 10 2011 100 440.1

(51) Int. Cl. G01S 3/02

(52) U.S. Cl. 342/450

(57) ABSTRACT

An exemplary position sensor can be provided that can include a transmitting arrangement for configured to generate electromagnetic waves, a receiving arrangement configured to detect electromagnetic waves, and a position arrangement. The transmitting arrangement and the receiving arrangement can be moved relative to the position arrangement. The position arrangement can influence the electromagnetic waves of the transmitting arrangement such that the presence of the position arrangement can be detected in the vicinity of the transmitting arrangement and the receiving arrangement.

### CROSS-REFERENCE TO RELATED APPLICATIONS

This application claims priority to German Patent Application No 10 2011 100 440.1, filed on May 4, 2011, the entire disclosure of which is incorporated herein by reference.

### FIELD OF THE DISCLOSURE

The present disclosure relates generally to a position sensor, and more specifically, relates to exemplary embodiments of a position sensor for use on or in, e.g., a vehicle seat.

### BACKGROUND INFORMATION

In motor vehicles today, even with all of the current safety technology, a driver or passenger can still be injured. Danger to a driver may arise if the driver's seat is positioned very far forward (close to the steering wheel) and the driver's air bag is deployed in the event of a collision. Due to this short distance to the steering wheel, and the airbag that is deployed, if the airbag deploys with its maximum possible speed, the airbag can impact the driver and cause unwanted, potentially severe, injuries.

Typically, the position of the driver's seat is not detected. In some higher classes of motor vehicles, such as luxury motor vehicles, the positioning of the seat can be determined if the seat adjustment is carried out using actuators. In such vehicles, hall sensors are typically used to detect the position of the seat. A problem with the current schemes and systems of seat distance detection, however, is that they are complex and, therefore, can be very expensive to utilize and/or implement.

Thus, it may be beneficial to provide is a seat position sensor that is simple, inexpensive, and that can easily be employed by all class levels of motor vehicles to reliably detect vehicle seat position, and which can overcome at least some of the deficiencies described herein above.

### SUMMARY OF EXEMPLARY EMBODIMENTS

Exemplary embodiments of the present disclosure relate to a seat position sensor. The exemplary seat position sensor can have a transmitting arrangement and/or unit which can be configured to generate electromagnetic waves, a receiving arrangement and/or unit which can be configured to detect electromagnetic waves, and a position arrangement and/or element. The transmitting arrangement and the receiving arrangement can be moveable relative to the position element. The position arrangement can modify the electromagnetic waves of the transmitting arrangement such that the presence of the position arrangement can be detected in the vicinity of one or both of the transmitting arrangement or the receiving arrangement.

According to one exemplary embodiment of the present disclosure, a position sensor can be arranged on or in a vehicle seat such that the position of the seat can be detected whether or not the vehicle seat is in a pre-determined position. The transmitting arrangement and the receiving arrangement can be arranged on a movable track of a vehicle seat, and the position arrangement can be arranged on a stationary track. The transmitting arrangement, the receiving arrangement, and the position arrangement can be dimensioned such that a single position, e.g., a particular locking position of the vehicle seat, can be detected. Alternatively, the transmitting arrangement, the receiving arrangement, and the position arrangement can be dimensioned such that it is possible to specify a range, e.g., a plurality of adjacent locking positions, as the detectable position.

For example, the functioning of the position sensor can also be facilitated if the position element is arranged on the movable track of the seat and the transmitting arrangement and the receiving arrangement are arranged in a stationary position on the track which receives the movable track.

According to another exemplary embodiment of the present disclosure, the position sensor can also be used on other movable parts, such as a window panel or a steering column, to detect whether or not the respective parts are in a predetermined position. The transmitting arrangement can generate electromagnetic waves which can comprise one frequency of a waveform, a plurality of frequencies of a waveform, a digital bit sequence, a pulse-width modulation, a pulse-period modulation, a noise signal and/or a modulated radio signal. The position arrangement can modify the electromagnetic waves. To facilitate this, the position arrangement can include or be, for example, an, an electrically conducting element or an element having an electrically conducting coating. The transmitting arrangement can comprise an inductance element or component and a set of electronics for driving the inductance element or component. An inductance element or component, e.g., in the range of about 100 microH and 1 mH, can be excited with a frequency between 1 kHz and 1 MHz. The inductance element or component can also be excited with a frequency between about 10 kHz and 220 kHz; preferably, the inductance element or component can be excited with a frequency between about 180 kHz and 220 kHz. The inductance element or component of the transmitting arrangement can comprise an air coil or a coil with a ferrite core, although not limited thereto.

The receiving arrangement can comprise an inductance element or component and a set of electronics that are suitable for detecting and processing the electromagnetic waves generated by the transmitting unit. For this purpose, the electronics of the receiving arrangement can comprise a comparator, although not limited thereto.

In one further exemplary embodiment of the present disclosure, the inductance element or component of the transmitting arrangement and the inductance element or component of the receiving arrangement can be arranged at a distance of about 7 mm to 13 mm apart. Preferably, such exemplary distance can be about 10 mm. A gap can thus be provided, into which the position arrangement can be easily inserted without striking one of the arrangements/units or being clamped between the arrangements/units.

These and other objects of the exemplary embodiments of the present disclosure can be achieved by provision of a position sensor having a position element, a transmitting arrangements moveable relative to the position element, the transmitting arrangements configured to transmit a signal, and a receiving arrangements moveable relative to the position element, the receiving arrangements configured to receive the signal. The position element can modify the signal when the transmitting arrangements is within a predetermined distance of the position element.

In further exemplary embodiments of the present disclosure, the transmitting arrangements and the receiving arrangements can be arranged on a movable track of a vehicle seat, and the position element can be arranged on a stationary track. In yet further exemplary embodiments of the present disclosure, the transmitting arrangements generates electromagnetic waves comprising a frequency of a waveform, a plurality of frequencies of a waveform, a digital bit sequence, a pulse-width modulation, a pulse-period modulation, a noise signal, and/or a modulated radio signal. According to still additional exemplary embodiments of the present disclosure, the position element can be an inductance element or component, an electrically conducting element, or an element having an electrically conducting coating. In yet additional exemplary embodiments of the present disclosure, the transmitting arrangements can comprise a first inductance element or component and a first set of electronics for driving the first inductance element or component.

According to certain exemplary embodiments of the present disclosure, the receiving arrangements can comprise a second inductance element or component and a second set of electronics, the second set of electronics comprising a comparator. In yet further exemplary embodiments of the present disclosure, the first inductance element or component can be excited with a frequency between about 1 kHz and 1 MHz. In additional exemplary embodiments of the present disclosure, the first inductance element or component can be excited with a frequency between about 10 kHz and 220 kHz. For example, the transmitting arrangements can comprise a first inductance element or component and the receiving unit comprises a second inductance element or component, and the first inductance element or component and the second inductance element or component can be arranged at a distance of about 7 mm to 13 mm apart. In still further exemplary embodiments of the present disclosure, the signal can be an electromagnetic wave.

According to another exemplary embodiment of the present disclosure, a method can be provided for determining the position of a seat by, e.g., providing a transmitting arrangement and/or unit moveable relative to a position element, providing a receiving arrangement and/or unit moveable relative to the position arrangement and/or element, transmitting a signal from the transmitting arrangement and/or unit to the receiving arrangement and/or unit, and modifying the signal when the transmitting arrangement and/or unit is within a predetermined distance of the position arrangement and/or element.

These and other objects, features and advantages of the exemplary embodiments of the present disclosure will become apparent upon reading the following detailed description of the exemplary embodiments of the present disclosure, when taken in conjunction with the appended claims.

### BRIEF DESCRIPTION OF THE DRAWINGS

Further objects, features and advantages of the present disclosure will become apparent from the following detailed description taken in conjunction with the accompanying Figures showing illustrative embodiments of the present disclosure, in which:

FIG. 1 is a schematic diagram of a position sensor according to a first exemplary embodiment of the present disclosure;

FIG. 2 is a schematic diagram of the position sensor according to a second exemplary embodiment of the present disclosure; and

FIG. 3 is a schematic diagram of the position sensor according to a third exemplary embodiment of the present disclosure arranged on a seat track.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures.

### DETAILED DESCRIPTION

The exemplary embodiments of the present disclosure may be further understood with reference to the following description and the related appended drawings. The exemplary embodiments of the present disclosure relate to a position sensor for detecting a vehicle seat position. Specifically, the device uses a transmitting unit, a receiving unit, and a position element to determine a vehicle seat position. The exemplary embodiments are described with reference to a vehicle seat position, although those having ordinary skill in the art will understand that the exemplary embodiments of the present disclosure may be implemented on any seat, or in any instance that requires a position detection.

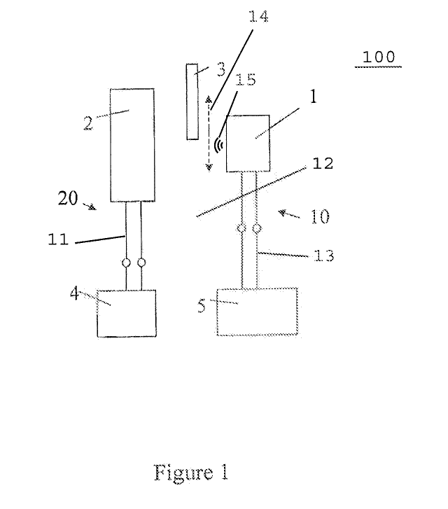

FIG. 1 shows a schematic diagram of a position sensor/arrangement/configuration 100 according to an exemplary embodiment of the present disclosure. The exemplary position sensor/arrangement/configuration 100 can include a transmitting unit (or arrangement) 10 has a first inductance element or component 1 and a first set of electronics 5 for driving the first inductance element or component 1. The first inductance element or component 1 is connected to the first set of electronics 5 via cables 13. A receiving unit (or arrangement) 20 has a second inductance element or component 2, which is connected via cables 11 to a second set of electronics 4. The exemplary transmitting unit (or arrangement) 10 and the receiving unit (or arrangement) 20 can be arranged substantially parallel to each other, and can form a gap 12 into which a position element (or arrangement) 3 can be inserted and/or removed there from. The relative motion between the position element 3, the transmitting unit 10, and receiving unit 20 is indicated by the arrow 14 in FIG. 1.

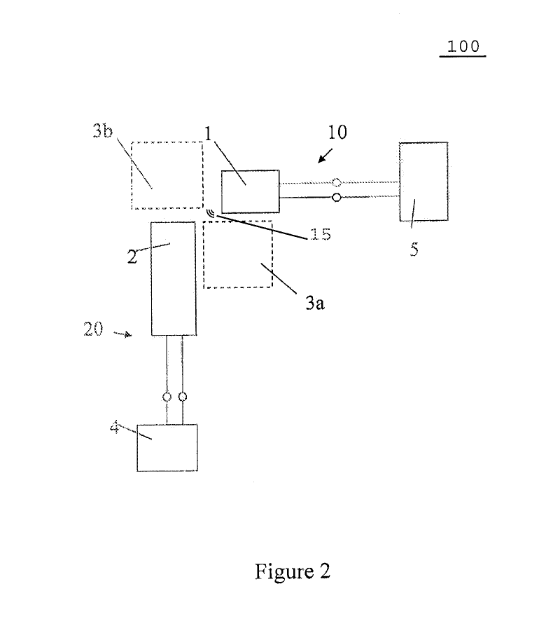

As shown in FIG. 2, the transmitting unit 10 and the receiving unit in 20 can be arranged substantially perpendicular with respect to each other. This can result in, e.g., two possible arrangements for the position element 3 (either element 3a or element 3b shown in FIG. 2). The position element 3 can be used to modify the electromagnetic waves emitted by the first inductance element or component 1 of the transmitting unit 10 such that the second inductance element or component 2 of the receiving unit 20 can detect a difference in the electromagnetic waves emitted. During the activation of the position sensor 100, the first inductance element or component 1 can transmit at least one signal 15, which can generated by using the first set of electronics 5. The signal 15 can include a plurality of frequencies of a standard waveform, a digital bit sequence, a PWM or a noise signal, and/or, e.g. a modulated radio signal, or the like. The second inductance element or component 2 of the receiving unit 20 can detect the signal 15 transmitted from the transmitting unit 10. The second set of electronics 4 of the receiving unit 20 can analyze the signal 15 and generate a corresponding information signal for further processing by the general vehicle electronics.

Once the position element 3 enters the vicinity of the transmitting unit 10, the position element 3 can modify the transmitted signal 15, for example, in amplitude and/or phase. In this exemplary manner, for application in a motor vehicle, an inexpensive set of electronics can be provided (e.g., Low Cost Electronics).

With a timer component or an inverter circuit, a waveform can be provided which is rectangular, sinusoidal, pulsed or of a shape similar to that of a charging or discharging process which can occur when charging or discharging capacitors or coils. With an additional component, the frequencies can be modified. It is thus possible, for example with a standard dual timer LM556, to generate a rectangular frequency of e.g., about 180 kHz up to 220 kHz in about the 100 ms range, although not limited thereto. With the standard CMOS and bipolar dual timers, frequencies from the low Hz to the MHz range can be generated, and the temporal change of frequency could be modulated onto this in the same range although not limited thereto. The modulation frequency can preferably be at least approximately 5 times lower although not limited thereto.

With a hex inverter, the same or similar circuit can be provided at similarly low cost. The receiver can be an air-core coil or a coil with capacitor (a so-called LC resonant circuit) although not limited thereto. The capacitor can be adapted to the coil or in the electronics. The electronics for the receiver can comprise a data acquisition unit (or arrangement), although it is not limited thereto. Simple and inexpensive data acquisition can be implemented with a comparator although not limited thereto. The comparator can compare whether the voltage of a half-wave of sinusoidal signal of the LC resonant circuit exceeds a reference value of the comparator realized by means of a voltage divider. An output signal can thus be generated.

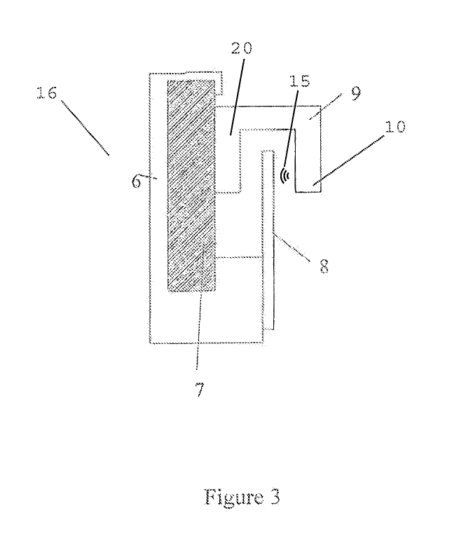

FIG. 3 illustrates a schematic diagram of the exemplary position sensor 100 according to another exemplary embodiment of the present disclosure which is arranged on a seat track 16. The exemplary position sensor 100 can be deployed on a seat track 16, as a so-called “seat track position sensor” or “seat position sensor”. The seat track 16 can have a movable track 7, which can hold the seat of a vehicle, and a stationary track 6 which can be connected to a car chassis. The combination 9 of the transmitting unit 10 and the receiving unit 20 can be arranged on the movable track 7 and the position element 8, e.g., in the form of a metallic arm, can be arranged on the stationary track 6. Depending on the position of the vehicle seat relative to the car chassis in the direction of travel, the position element 8 can be located in the recess between the transmitting unit 10 and the receiving unit 20, whereby a seat track position sensor or seat position sensor can be implemented.

A transmitter inductance element or component, for example in the range of about 100 pH to 1 mH, can be excited with a frequency of about 180 kHz to 220 kHz, although not limited thereto. The frequency can be cyclically varied, linearly in 1 ms steps. For the receiver, an LC resonant circuit with a resonance frequency of, for example, about 200 kHz can be used.

The transmitter and receiver inductance element or components can be spaced apart by a distance of, for example, 10 mm although not limited thereto. The dual timer and the comparator can be mounted on a circuit board which is arranged on the upper track. The lower track can have a metallic arm, which is displaced between the transmitter and receiver inductance element or components according to the seat position. This can result in an output signal. It is noted that the position element 8, e.g. the metallic arm, can be a separate component, which can be attached to the track, or can be constructed integrally with the track, for example as a projection or angle.

The current consumption can be between 2 mA to 8 mA. If a transistor switches a load via the comparator, the current consumption can be increased to between about 12 mA and 17 mA; an output signal which is standard in the automotive industry, a 2-wire signal, can therefore be generated.

This new position sensor can also be mounted inside a complex vehicle seat track. An advantage here is that the inductive barrier cannot be affected by a static magnetic field.

Accordingly an inexpensive and reliable system and method can be provided for detecting the position of a vehicle seat using the exemplary sensor arrangement(s) described herein. Such exemplary position sensor arrangements can have the advantage in that it is less expensive to produce, and easily installed on new and existing car models of any class level.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

What is claimed is:

1. A position sensor, comprising:
a position arrangement;
a transmitting arrangement moveable relative to the position arrangement, the transmitting arrangement being configured to transmit a signal;
a receiving arrangement moveable relative to the position arrangement, the receiving arrangement being configured to receive the signal; and
wherein the position arrangement modifies the signal when at least one of the transmitting arrangement or the receiving arrangement is within a predetermined distance from the position arrangement.

2. The position sensor according to claim 1, wherein the transmitting arrangement and the receiving arrangement are arranged on a movable track of a vehicle seat, and wherein the position arrangement is arranged on a stationary track.

3. The position sensor according to claim 1, wherein the transmitting arrangement is configured to generate at least one electromagnetic wave which comprises at least one of one frequency of a waveform, a plurality of frequencies of a waveform, a digital bit sequence, a pulse-width modulation, a pulse-period modulation, a noise signal, or a modulated radio signal.

4. The position sensor according to claim 1, wherein the position arrangement includes at least one of an inductance arrangement, an electrically conducting arrangement, or an arrangement having an electrically conducting coating.

5. The position sensor according to claim 1, wherein the transmitting arrangement comprises an inductance arrangement and a set of electronics for driving the first inductance arrangement.

6. The position sensor according to claim 1, wherein the receiving arrangement comprises an inductance arrangement and a set of electronics, the set of electronics including a comparator.

7. The position sensor according to claim 5, wherein the inductance arrangement is excited with a frequency between about 1 kHz and 1 MHz.

8. The position sensor according to claim 5, wherein the inductance arrangement is excited with a frequency between about 10 kHz and 220 kHz.

9. The position sensor according to claim 1, wherein the transmitting arrangement comprises a first inductance element or component and the receiving arrangement comprises a second inductance element or component, and the first inductance arrangement and the second inductance element or component are arranged at a distance of about 7 mm to 13 mm apart.

10. The position sensor according to claim 1, wherein the signal is an electromagnetic wave.

11. A method of determining a position comprising the steps of:
causing a transmission of a signal from a transmitting arrangement to a receiving arrangement, wherein the transmitting arrangement is moveable relative to the position arrangement, and the receiving arrangement is moveable relative to the position arrangement; and
modifying the signal when at least one of the transmitting arrangement or the receiving arrangement is within a predetermined distance from the position arrangement.

12. The method according to claim 11, wherein the transmitting arrangement and the receiving arrangement are arranged on a movable track of a vehicle seat and wherein the position arrangement is arranged on a stationary track.

13. The method according to claim 11, wherein the transmitting arrangement is configured to generate at least one electromagnetic wave which comprises at least one of one frequency of a waveform, a plurality of frequencies of a waveform, a digital bit sequence, a pulse-width modulation, a pulse-period modulation, a noise signal, or a modulated radio signal.

14. The method according to claim 11, wherein the position arrangement includes at least one of an inductance element or component, an electrically conducting arrangement, or an arrangement having an electrically conducting coating.

15. The method according to claim 11, wherein the transmitting arrangement comprises a first inductance element or component and a set of electronics for driving the inductance element or component.

16. The method according to claim 11, wherein the receiving arrangement comprises a second inductance element or component and a set of electronics, the set of electronics being a comparator.

17. The method according to claim 15, wherein the first inductance element or component is excited with a frequency between about 1 kHz and 1 MHz.

18. The method according to claim 15, wherein the first inductance element or component is excited with a frequency between about 10 kHz and 220 kHz.

19. The method according to claim 11, wherein the transmitting arrangement comprises a first inductance element or component and the receiving arrangement comprises a second inductance element or component, and the first inductance element or component and the second inductance element or component are arranged at a distance of about 7 mm to 13 mm apart.

20. The method according to claim 11, wherein the signal is an electromagnetic wave.
